(19) United States
(12) Patent Application Publication
(10) Pub. No.: US 2005/0025008 A1
(43) Pub. Date: Feb. 3, 2005

(54) Method for generating header and transition flags using DPD technology and optical device using the same

(76) Inventors: Ying-Tzung Wang, Hsinchu (TW); Chien-Ming Chen, Hsinchu (TW)

Correspondence Address: BIRCH STEWART KOLASCH & BIRCH, PO BOX 747, FALLS CHURCH, VA, 22040-0747, US

(21) Appl. No.: 10/928,088

(22) Filed: Aug. 30, 2004

Related U.S. Application Data
(63) Continuation-in-part of application No. 09/949,748, filed on Sep. 12, 2001, now Pat. No. 6,801,484.

(51) Int. Cl. G11B 5/09

(52) U.S. Cl. 369/47.22; 369/47.27

(57) ABSTRACT

A method for generating header and groove/land transition flags using the DPD technology and an apparatus using the same are disclosed. The method first sets a first and a second threshold levels. Then, the method generates a phase difference signal. The method generates a first transition flag signal and a second transition flag signal, wherein the first transition flag signal is enabled when the phase difference signal is greater than the first threshold level and the second transition flag signal is enabled when the phase difference signal is smaller than the second threshold level. The method then generates a header flag signal according to the first and the second transition flag signal.

### CROSS-REFERENCE TO RELATED APPLICATIONS

This invention is a continuation-in-part of commonly assigned U.S. patent application Ser. No. 09/949,748, filed Sep. 12, 2001.

### BACKGROUND

The present invention belongs to an optical disk device, and more particularly relates to a device and a method for generating a header flag signal and a land/groove transition flag signal using the DPD (Differential Phase Detection) technology.

In the DVD-RAM (Digital Versatile Disk RAM) structure, there are wobbled spiral groove and land tracks, and the phase change recording method is used at the centers of groove and land to reach the high density recording capacity. FIG. 1 shows such a track structure of wobbled grooves 13 and lands 14.

As shown in the drawing, each groove/land track is divided into several sectors. The user's data are continuously recorded on the groove/land track in units of ECC (Error Code Correction) blocks. Each ECC block consists of 16 sectors. As shown in FIG. 1, each sector has previously etched with a header field, containing a first/second header field 11, a third/fourth header field 12, and having half-track pitch offsets in the radial direction. The header field of each sector has the same embossed pit/land structure as the DVD-ROM and contains CAPA's (Complementary Allocated Pit Address) data. Furthermore, as shown in FIG. 1, at the intersection of each loop of groove and land (such as the position 15 shown in the drawing) the last sector of the groove (land) connects to the first sector of the land (groove), and at the same time the polarities of the first/second header field 11 and the third/fourth header field 12 are changed.

To read the data in the DVD-RAM, the reading system has to use a header flag signal and a groove/land transition flag signal to control the reading actions, wherein the header flag signal is used to represent the header field of the sector, and the groove/land transition flag signal is used to indicate whether the track is a land one or a groove one. Nowadays, the so-called high frequency push-pull tracking method is used to generate the header flag signal and the groove/land transition flag signal according to the embossed header field. FIG. 2 shows two exemplar push-pull CAPA signal waveforms 20a and 20b of the push-pull CAPA signal. Note that the polarities of the push-pull CAPA signal waveforms 20a and 20b are opposite to each other in these two cases. As shown in FIG. 2, the signal level of the push-pull CAPA signal is typically very low except at the header fields, e.g. the header fields 20a and 20b. At the header field, the level of the push-pull CAPA signal increases/decreases according to the polarity of the header field.

Conventionally, the system will use a low-pass filter to filter the push-pull CAPA signal so as to obtain a filtered push-pull CAPA signal. The waveforms 21a and 21b shown in FIG. 3 are the exemplar waveforms of the filtered push-pull CAPA signal corresponding to the push-pull CAPA signal waveforms 20a and 20b, respectively. After comparing the filtered push-pull CAPA signal with preset high and low threshold levels 22, 23, a first transition flag signal CP1 and a second transition flag signal CP2 are generated such that the first transition flag signal CP1 becomes enabled if the filtered push-pull CAPA signal is greater than the high threshold level, and the second transition flag signal CP2 becomes enabled if the filtered push-pull CAPA signal is lower than the low threshold level. The waveforms 24a and 24b in FIG. 3 are two exemplar waveforms of the first transition flag signal CP1, and the waveforms 25a and 25b are two exemplar waveforms of the second transition flag signal CP2.

Based on the first and the second transition flag signals, a header flag signal is generated such that the enabling period of the header flag signal includes the enabling periods of the first and the second transition flag signals. As an example, the waveform 26a shows the header flag signal generated in accordance with the first transition flag signal 24a and the second transition flag signal 25a. As another example, the waveform 26b shows the header flag signal generated in accordance with the first transition flag signal 24b and the second transition flag signal 25b.

Based on the enabling time points of the first and the second transition flag signals, the groove/land transition flag signal is generated. If the first transition flag signal CP1 is enabled earlier than the second transition flag signal CP2, the groove/land transition flag signal becomes logic high (or alternatively logic low) to indicate that the groove data are being read and the system has to track the groove. As an example, the waveform 27a shows the groove/land transition flag signal generated in accordance with the first transition flag signal 24a and the second transition flag signal 25a, assuming that the original logic level of the groove/land transition flag signal is logic low. On the other hand, if the second transition flag signal CP2 is enabled earlier than the first transition flag signal CP1, the groove/land transition flag signal becomes logic low (or alternatively logic high) to indicate that the land data are being read and the system has to track the land. As an example, the waveform 27b shows the groove/land transition flag signal generated in accordance with the first transition flag signal 24b and the second transition flag signal 25b, assuming that the original logic level of the groove/land transition flag signal is logic high.

Unfortunately, the push-pull CAPA signal is very sensitive to the lens shift, hence greatly influencing the correctness while generating the header flag signal and groove/land transition flag signal. FIG. 4 shows two exemplar deformed waveforms 21c and 21d of the filtered push-pull CAPA signal due to lens shifts. As shown in the drawing, it is impossible to correctly generate the first and second transition flag signals according to the high and low threshold levels due to the push-pull CAPA signal deformation. Consequently, neither the header flag signal nor the groove/land transition flag signal can be properly generated. This will result in the control system's being unable to function correctly.

A header region detecting method and apparatus, which is published on Apr. 4, 2002 in the U.S. application publication No. 2002/0039331 A1, uses a DPD signal generating section to generate the tracking error signal according to the RF signals and uses a upper slicing section and a lower slicing section to respectively generate first and second header detection signals by slicing the tracking error signal with a single predetermined slice level. Therefore, a header mask signal is generated by logically combining the first and second header detection signals. Since the upper and lower slicing sections use the same slicing level, how to set or adjust the slicing level could become a challenging issue for obtaining proper the header detection signals. Further more, the DPD signal contains information corresponding to three portions: the first/second header field, the third/fourth header field, and the user's data. Only one slice level can be used to distinguish only two kinds of information. To distinguish more than two kinds of information, one slice level would be not enough.

### SUMMARY OF THE INVENTION

In view of the foregoing, an object of the invention is to provide a method for correctly generating a header flag signal and a groove/land transition flag signal without being influenced by lens shifts.

Another object of the invention is to provide a method for generating a header flag signal and a groove/land transition flag signal using the DPD technology.

The disclosed method includes the steps of: setting first and second threshold levels; generating a phase difference signal; generating a first transition flag signal by comparing the phase difference signal with the first threshold level and a second transition flag signal by comparing the phase difference signal with the second threshold level; and generating a header flag signal and a groove/land transition flag signal according to the first and the second transition flag signals.

### BRIEF DESCRIPTION OF THE DRAWINGS

The present invention will become more fully understood from the detailed description given hereinbelow illustration only, and thus are not limitative of the present invention, and wherein:

FIG. 1 shows a wobbled groove and land track structure for DVD-RAM.

FIG. 2 shows two exemplar signal waveforms of the push-pull CAPA signal.

FIG. 3 shows the signal waveforms of the filtered push-pull CAPA signal, the corresponding first/second transition signals, the header flag signal and the groove/land transition flag signal for two exemplar cases.

FIG. 4 shows the signal waveforms of the filtered push-pull CAPA signal, the corresponding first/second transition signals for two exemplar cases considering the lens shift.

FIG. 5 is a schematic view showing a laser beam passing the sector boundary along a track.

FIG. 6 shows the phase difference signal variation when the laser beam passes through the header field in the radial direction.

FIG. 7 shows a phase difference signal generated by the DPD technology at a sector intersection.

FIG. 8 shows a flowchart of generating header flag signal and groove/land transition flag signal using the DPD technology.

FIG. 9 is a block diagram of an optical device for generating header flag signal and groove/land transition flag signal using the DPD technology.

FIG. 10 shows a circuit of the transition flag signal generating unit in FIG. 9.

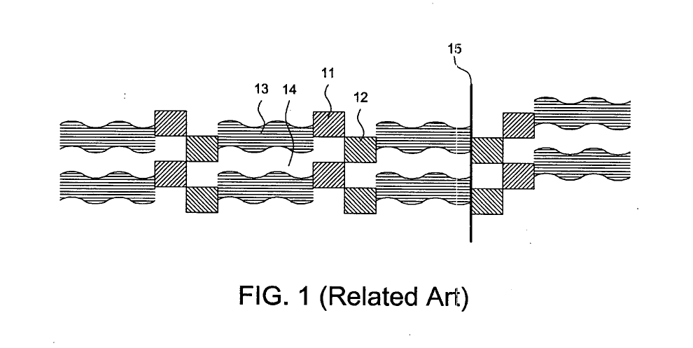

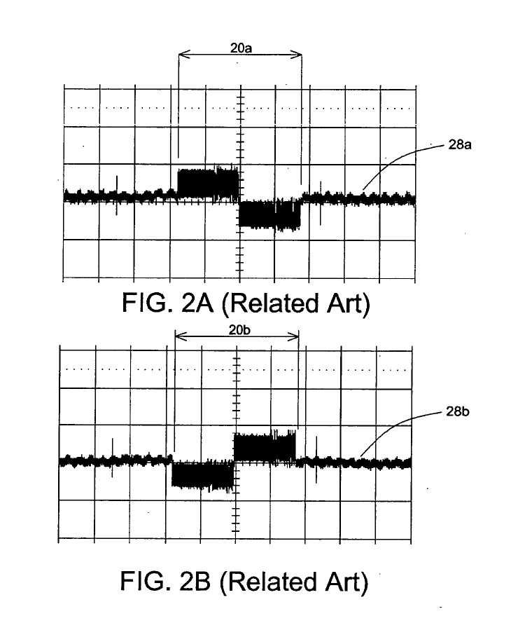

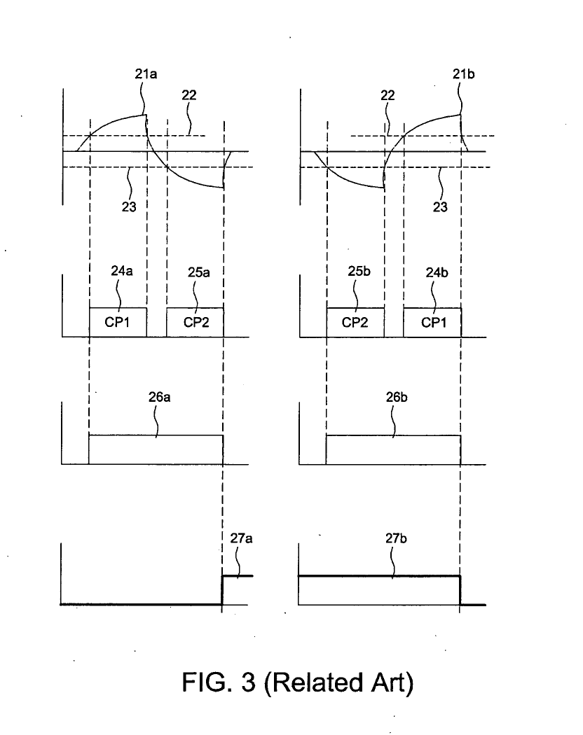

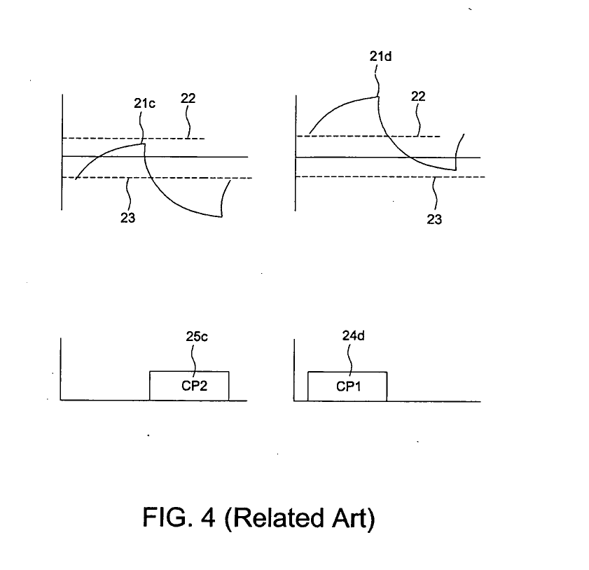

### DETAILED DESCRIPTION OF THE INVENTION

The DPD (Differential Phase Detection) technology is usually used in DVD-ROM systems to check whether the optical head is in alignment with tracks and to generate a phase difference signal while crossing tracks. The invention uses the DPD technology in generating the header flag signal and the groove/land transition flag signal for DVD-RAM tracking.

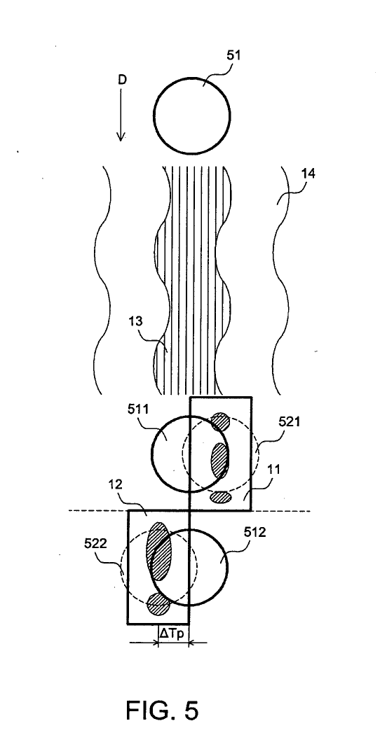

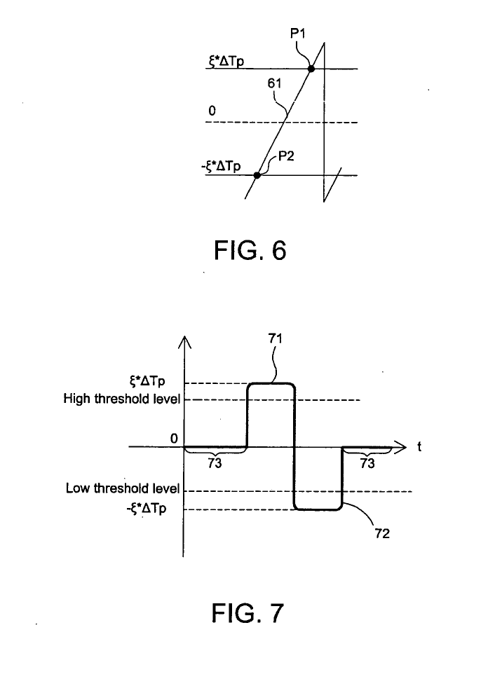

The following paragraphs explain the principle and method of generating the header flag signal and the groove/land transition flag signal during DVD-RAM tracking. FIG. 5 is a schematic view showing a laser beam passing the sector boundary along a track, while FIG. 6 shows the phase difference signal variation when the laser beam passes through the header field in the radial direction. As shown in FIG. 5, when a laser beam 521 aims at a first/second header field 11, the level of the phase difference signal 61 is 0 (see also FIG. 6). When the laser beam moves toward the left side of FIG. 5, the level of the phase difference signal 61 slowly increases. When the laser beam moves to the location 511, the level of the phase difference signal 61 is the value of P1. That is, P1=ξ*Δ Tp, where Δ Tp is the offset distance between the laser beam 521 and the track center and ξ is defined as the proportion coefficient from the offset distance to the phase difference signal. The position 511 of the laser beam is right at the track center of the DVD-RAM. Furthermore, when the laser beam 522 aims at a third/fourth header field 12, the level of the phase difference signal 61 is 0 (see FIG. 6). When the laser beam moves to the right side of FIG. 5, the level of the phase difference signal 61 slowly decreases. When the laser beam moves to the location 522, the level of the phase difference signal 61 is the value of P2. That is, P2=−ξ*Δ Tp, where Δ Tp is the offset distance between the laser beam 522 and the track center and ξ is defined as the proportion coefficient from the offset distance to the phase difference signal. The position 512 of the laser beam is right at the track center of the DVD-RAM.

Therefore, when the laser beam 51 follows the tracking direction D and enters from the phase change area 13/14 to the first/second header field 11, the third/fourth header field 12, and the phase change area 13/14 of another sector, the phase difference signal generated by the DPD technology is shown in FIG. 7, as an example, where the horizontal axis is time and the vertical axis is the level of the phase difference signal. In FIG. 7, the waveform 71 is the waveform of the obtained phase difference signal when the laser beam 51 passes through the first/second header field 11, and the waveform 72 is the waveform of the obtained phase difference signal when the laser beam 51 passes through the third/fourth header field 12. Since the DPD technology produces a relatively small phase difference signal level during the phase change areas, hence the corresponding waveform 73 is a waveform around 0 level. Due to the difference of the signal levels, the waveform portions of the phase difference signal respectively corresponding to the header fields and the phase change areas can thus be clearly distinguished. Moreover, since lens shifts have very little effect on the phase difference signal, two high and low threshold levels and can be unambiguously defined.

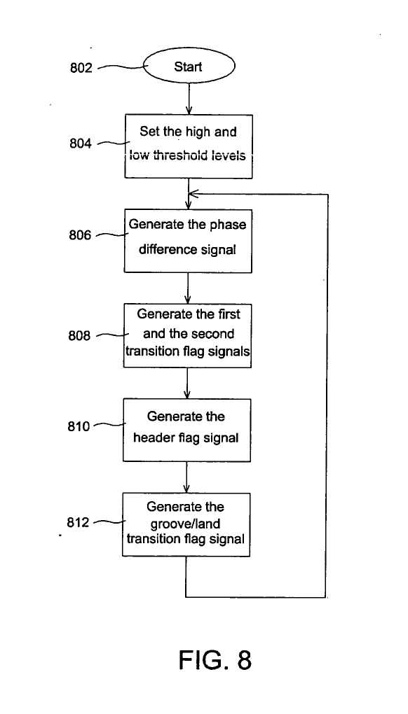

The flowchart of the FIG. 8 explains the disclosed method of generating a header flag signal and a groove/land transition flag signal using the DPD technology. The steps are following:
Step 802: Start.
Step 804: Set the high and low threshold levels. The high threshold level is higher than the low threshold level
Step 806: Generate the phase difference signal. The DPD technology is employed to generate the phase difference signal in the tracking direction.
Step 808: Generate a first transition flag signal CP1 and a second transition flag signal CP2. The first transition flag signal CP1 is enabled if the phase difference signal is greater than the high threshold level. The second transition flag signal CP2 is enabled if the phase difference signal is smaller than the low threshold level.
Step 810: Generate a header flag signal according to the first and the second transition flag signals CP1 and CP2. The header flag signal is enabled when the first transition flag signal CP1 appears before the second transition flag CP2. The header flag signal is also enabled when the second transition flag signal CP2 appears before the first transition flag CP1. In these two cases, the header flag signal will be enabled in such a manner that an enabled period of the header flag signal contains enabled periods of the first and the second transition flag signals.
Step 812: Generate a groove/land transition flag signal based on the first and the second transition flag signal. The groove/land transition flag signal becomes logic high to indicate the groove data are being reading, if the first transition flag signal is enabled earlier than the second transition flag signal, and the groove/land transition flag signal becomes logic low to indicate the land data are being reading, if the second transition flag signal is enabled earlier than the first transition flag signal.

The invention uses the DPD technology to generate the phase difference signal in the tracking direction and, generate a first and a second transition flag signal by comparing the phase difference signal with the high and low threshold levels. Subsequent procedures following the production of the first and the second transition flag signal are the same as those in the prior art and therefore are not further described herein.

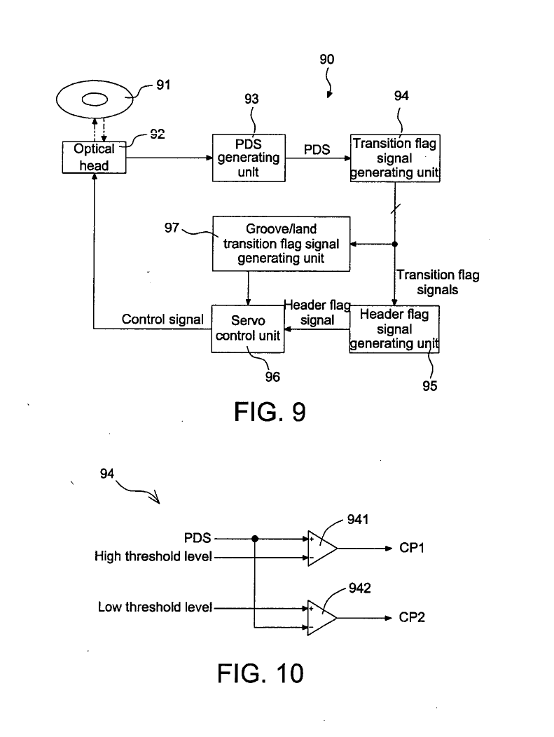

FIG. 9 is a block diagram of an optical device for generating a header flag signal and a groove/land transition flag signal using the DPD technology. As shown in the FIG. 9, an optical control device 90 uses a phase difference signal (PDS) generating unit 93 to generate a phase difference signal PDS according to the signal output from an optical head 92. A transition flag signal generating unit 94 then compares the phase difference signal PDS with a high and a low threshold levels and respectively generates a first and a second transition flag signals. The high threshold level is higher than the low threshold level. The first transition flag signal CP1 is enabled if the phase difference signal PDS is greater than the high threshold level. A second transition flag signal CP2 is enabled if the phase difference signal PDS is smaller than the low threshold level. Afterwards, a header flag signal generating unit 95 generates a header flag signal according to the first and the second transition flag signals CP1 and CP2. The header flag signal is enabled if the first transition flag signal CP1 appears before the second transition flag CP2. The header flag signal is also enabled if the second transition flag signal CP2 appears before the first transition flag CP1. A groove/land transition flag signal generating unit 97 generates a groove/land flag signal according to the first and the second transition flag signals CP1 and CP2. The groove/land transition flag signal becomes logic high to indicate the groove data are being reading, if the first transition flag signal is enabled earlier than the second transition flag signal, and the groove/land transition flag signal becomes logic low to indicate the land data are being reading, if the second transition flag signal is enabled earlier than the first transition flag signal. A servo control unit 96 generates an appropriate control signal according to the header flag signal and the groove/land transition flag signal to control track locking and other relevant actions of the optical device.

FIG. 10 shows a circuit of the transition flag signal generating unit in FIG. 9. The transition flag signal generating unit 94 uses two comparators 941 and 942 to respectively generate the first transition flag signal CP1 and the second transition flag signal CP2 according to the phase difference signal PDS and the high/low threshold levels. The comparator 941 receives the phase difference signal PDS and the high threshold level and enables the first transition flag signal CP1 when the phase difference signal PDS is greater than the high threshold level. The comparator 942 receives the phase difference signal PDS and the low threshold level and enables the second transition flag signal CP2 when the phase difference signal PDS is smaller than the low threshold level.

Certain variations would be apparent to those skilled in the art, which variations are considered within the spirit and scope of the claimed invention.

1. A method for generating a header flag signal for representing a header field using the DPD technology, comprising the steps of:
setting first and second threshold levels, wherein the first threshold level is higher than the second threshold level;
generating a phase difference signal;
generating a first transition flag signal and a second transition flag signal, wherein the first transition flag signal is enabled when the phase difference signal is greater than the first threshold level and the second transition flag signal is enabled when the phase difference signal is smaller than the second threshold level; and
generating the header flag signal according to the first and the second transition flag signals, wherein an enabled period of the header flag signal contains enabled periods of the first and the second transition flag signals.

2. The method according to claim 1, further comprising the step of generating a groove/land transition flag signal based on the first and the second transition flag signal, wherein the groove/land transition flag signal becomes logic high if the first transition flag signal is enabled earlier than the second transition flag signal, and the groove/land transition flag signal becomes logic low if the second transition flag signal is enabled earlier than the first transition flag signal.

3. An apparatus for generating a header flag signal for representing a header field using the DPD technology, comprising:
a phase difference signal generating unit for generating a phase difference signal;
a transition flag signal generating unit for generating a first transition flag signal and a second transition signal according to the phase difference signal, and a first threshold level and a second threshold levels, the first transition flag signal being enabled when the phase difference signal is greater than the first threshold level, and the second transition flag signal being enabled when the phase difference signal is smaller than the second threshold level, wherein the first threshold level is higher than the second threshold level; and
a header flag signal generating unit for generating a header flag signal according to the first and the second transition flag signals, wherein an enabled period of the header flag signal contains enabled periods of the first and the second transition flag signals.

4. The apparatus according to claim 3, wherein the transition flag signal generating unit comprises:
a first comparator for receiving the phase difference signal and the first threshold level and enabling the first transition flag signal when the phase difference signal is greater than the first threshold level; and
a second comparator for receiving the phase difference signal and the second threshold level and enabling the second transition flag signal when the phase difference signal is smaller than the second threshold level.

5. The apparatus according to claim 3, further comprising an unit for generating a groove/land transition flag signal based on the first and the second transition flag signal, wherein the groove/land transition flag signal becomes logic high if the first transition flag signal is enabled earlier than the second transition flag signal, and the groove/land transition flag signal becomes logic low if the second transition flag signal is enabled earlier than the first transition flag signal.
